(19) United States
(12) Patent Application Publication
(10) Pub. No.: US 2026/0204878 A1
(43) Pub. Date: Jul. 16, 2026

(54) CORONA CHARGER AND METHODS OF USE AND MANUFACTURE OF THE SAME

(71) Applicant: University of Cincinnati, Cincinnati, OH (US)

(72) Inventors: Tao Li, Mason, OH (US); Chandrashekhar Choudhary, Cincinnati, OH (US)

(73) Assignee: University of Cincinnati, Cincinnati, OH (US)

(21) Appl. No.: 19/429,650

(22) Filed: Dec. 22, 2025

Related U.S. Application Data
(60) Provisional application No. 63/737,144, filed on Dec. 20, 2024.

(51) Int. Cl. H01T 19/04; G01N 15/00; G01N 15/06

(52) U.S. Cl. CPC H01T 19/04; G01N 15/0656; G01N 2015/0003; G01N 2015/0038

(57) ABSTRACT

A corona charger, methods for operating the same, and methods for fabricating electrodes therefor are disclosed. The corona charger includes an outer electrode having at least one rail, with each rail being provided with a plurality of discharge tips. The corona charger further includes a screen electrode provided within the outer electrode, and a ground electrode provided within the screen electrode. The set of electrodes are arranged within a housing that is configured to flow an airstream, such as an airstream with entrained particulate matter. As the airstream is flowed through the corona charger, voltages may be applied to the electrodes therein to charge particulates flowing therethrough and exhaust charged particulates from the corona charger.

### CROSS-REFERENCE TO RELATED APPLICATIONS

This application is related to the following U.S. Provisional Application No. 63/737,144 filed Dec. 20, 2024, the entire contents of which are incorporated herein by reference.

### TECHNICAL FIELD

The present disclosure relates to electrostatic charging devices and, more particularly, to unipolar corona chargers configured to impart electrical charge to particulates via corona discharge.

### BACKGROUND

Exposure to particulate matter has been linked to various adverse health conditions, including cardiopulmonary diseases, acute respiratory illness, lung cancer, cerebrovascular diseases, ischemic heart disease, and many others. The health impact of these airborne particles is closely related to their size, which influences how deeply they can penetrate into the respiratory system. Typically, the smaller the size of the particle, the greater the health risk associated with it, as smaller particles can penetrate deeper into the lungs and even enter into the bloodstream.

Low-cost, miniature sensors for monitoring for larger particles (e.g., particles of up to 2.5 μm or even 10 μm in diameter) are known in the art and used for personal exposure monitoring, respirator integrity monitoring, and other similar applications. However, the mechanisms by which these known sensors function (e.g., optical detection) are poorly suited for or incapable of monitoring for nanoparticles—that is, particles below 100 nm in diameter. Furthermore, aerodynamic mobility-based detection techniques rely on particle inertia, which becomes very small as the particle size goes below about 300 nm and is also ill-suited for nanoparticle detection.

Nanoparticles are generally considered to be more life-threatening than larger particles given that nanoparticles are typically present in higher concentrations and/or have a larger specific surface area upon which toxic substances might accumulate, and so a need exists for sensing schemes having compact form factors that can reliably detect nanoparticles.

### SUMMARY

In one aspect, a corona charger is provided, including an outer electrode having at least one rail, with each rail being provided with a plurality of discharge tips. The corona charger further includes a screen electrode provided within the outer electrode, and a ground electrode provided within the screen electrode. The set of electrodes are arranged within a housing that is configured to flow an airstream, such as an airstream with entrained particulate matter.

In one aspect, a method for using a corona charger is provided. The corona charger includes an outer electrode having at least one rail, with each rail being provided with a plurality of discharge tips. The corona charger further includes a screen electrode provided within the outer electrode, and a ground electrode provided within the screen electrode. The set of electrodes are arranged within a housing that is configured to flow an airstream, such as an airstream with entrained particulate matter. The method includes steps of: flowing the airstream through the corona charger; supplying a first voltage to the outer electrode and a second voltage to the screen electrode; charging particulates in the airstream; and exhausting the charged particulates from the corona charger.

In one aspect, a method for fabricating an outer electrode of a corona charger is provided, the method including steps of: attaching a first metal sheet to a first carrier; attaching a second metal sheet to a second carrier; cutting a plurality of discharge tips in the first metal sheet; patterning a rail in the second metal sheet; and bonding the plurality of discharge tips so formed to the rail.

These and additional features provided by the aspects described herein will be more fully understood in view of the following detailed description, in conjunction with the drawings.

### BRIEF DESCRIPTION OF THE DRAWINGS

The aspects set forth in the drawings are illustrative and exemplary in nature and not intended to limit the subject matter defined by the claims. The following detailed description of the illustrative aspects can be understood when read in conjunction with the following drawings, where like structure is indicated with like reference numerals and in which:

FIG. 1 schematically depicts a longitudinal or side perspective view of an exemplary corona charger as described and illustrated herein;

FIG. 2 schematically depicts an axial or transverse perspective view of an exemplary corona charger as described and illustrated herein;

FIG. 3 schematically depicts a perspective view of an exemplary corona charger as described and illustrated herein;

FIG. 4 schematically depicts a perspective view of a discharge tip as described and illustrated herein;

FIG. 5 schematically depicts a perspective view of an exemplary corona charger as described and illustrated herein;

FIG. 6 depicts an exemplary method for operating a corona charger as described and illustrated herein; and

FIG. 7 depicts an exemplary method for fabricating a corona discharger as described and illustrated herein.

### DETAILED DESCRIPTION

Aspects described herein pertain to corona chargers, methods for using the same, and methods for fabricating components thereof. The corona charger includes a housing through which an airstream may be flowed as well as an outer electrode having at least one rail arranged therein, with each rail being provided with a plurality of discharge tips. The corona charger further includes a screen electrode provided within the outer electrode, and a ground electrode provided within the screen electrode. As the airstream is flowed through the corona charger, voltages may be applied to and/or across the electrodes therein to generate ions which may then attach to and correspondingly charge those particulates flowing therethrough. The charged particulates may then be exhausted from the charger and pass on to a sensor for detecting and/or otherwise sorting the same.

As a result of this design, velocities within the ionization zone of the charger are kept to a minimum, likewise minimizing electrostatic losses resulting from charged particulates entering the same. The airstream remains mostly confined within the charging zone inside of the screen electrode, and so chargers consistent with those aspects disclosed herein may have a high efficiency, determined as the product of ion concentration Nᵢ and residence time t of a particle within the charger, as well as a compact size. In some aspects, particle losses of only 3.25% at 10.55 nm can be achieved in a form factor orders of magnitude smaller than other known particulate treatment schemes.

Corona discharge is an electrical phenomenon that occurs when a sufficiently high voltage is applied to an electrode, causing ionization of the surrounding gas or fluid in those regions in which the electric field intensity exceeds the dielectric breakdown strength of the fluid. This ionization process generates a plasma region containing free electrons and ions, the plasma region emanating from the electrode surface and extending into the surrounding space. The geometry of the electrode, the applied voltages, and the properties of the surrounding fluid influence the characteristics of the corona discharge, including its spatial extent and the rate of ion generation.

Corona chargers are devices that utilize corona discharge to impart electrical charge to target materials, particles, surfaces, and/or the like. In a corona charger, an electrode maintained at a relatively high voltage ionizes the surrounding fluid, typically air, and generates ions that migrate toward and deposit charge onto a target under the influence of the electric field. This ability to controllably impart charge to a diverse variety of targets or substrates, such as airborne particulates, films, webs, or even discrete objects, makes corona charging an important technology in fields such as manufacturing, sensing, environmental controls, and printing.

To more effectively detect nanoparticles, electrical mobility analyses can be used, during which particles in an airstream may be charged, such as by using a corona charger consistent with the disclosures herein, and the charged particles may subsequently be detected by electrometers or the like.

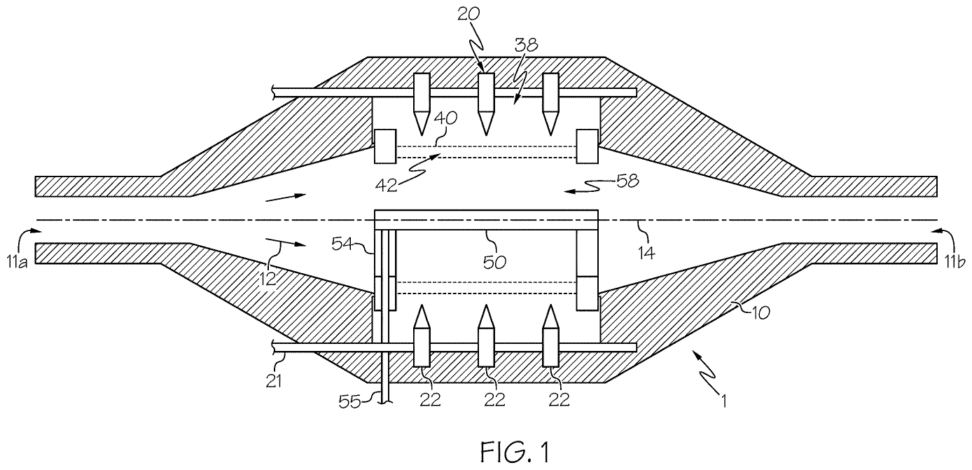

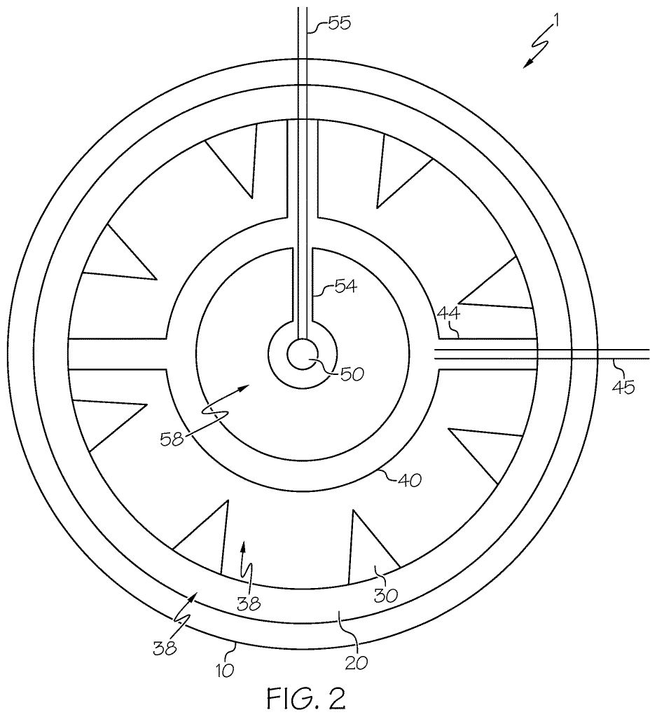

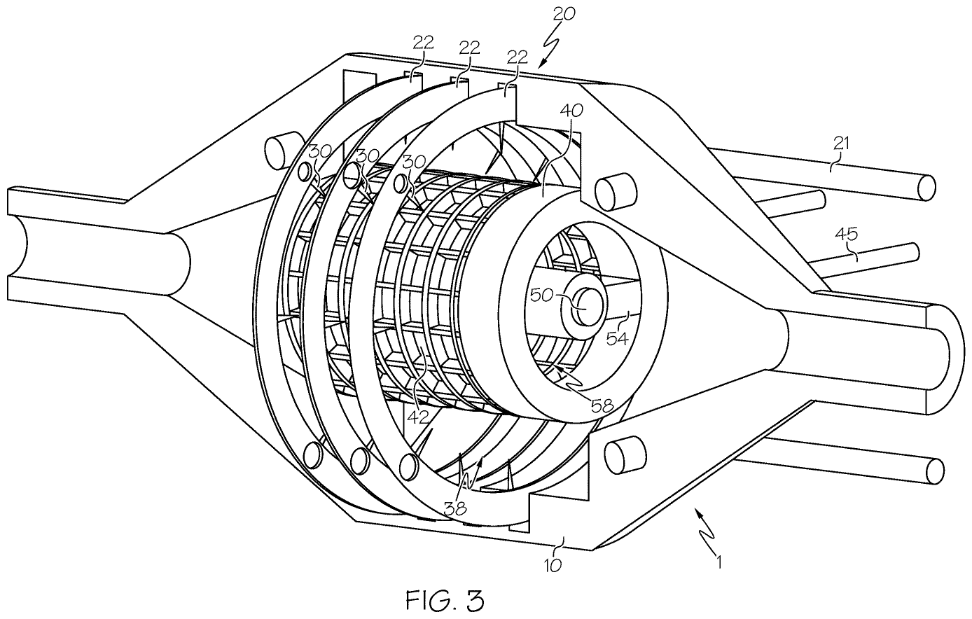

Turning now to FIGS. 1-3, perspective views of an exemplary corona charger 1 according to aspects of those disclosures herein is shown. The corona charger 1 has a housing 10 with a dominant axis 14 extending therethrough and which is configured to flow an airstream 12 (e.g., any gas or fluid, such as air, nitrogen, carbon dioxide, oxygen, a working fluid or working fluid mixture, and/or some mixture of any of the foregoing, without limit) that may or may not have particulates entrained therewith. The housing may have an inlet 11a and an outlet 11b. The housing 10 may be formed from plastic and/or some other material with structural and/or electrically-insulating properties. The housing 10 may be formed via additive manufacturing, casting, machining, and/or the like, without limit. The housing 10 may be formed as separate pieces that may be assembled, in some instances, so as to permit other components to be inserted before the housing 10 is closed.

The corona charger 1 may include at least one outer electrode 20 having at least one rail 22, each rail 22 having attached thereto a plurality of discharge tips 30. At least one interconnect 21 may be provided to connect the at least one outer electrode 20 to a voltage source.

In those aspects of FIGS. 1-3, each rail 22 is provided in the shape of a ring arranged about an outer portion of the corona charger 1 with the axis 14 extending substantially through a middle of the ring. In some aspects, a plurality of rails 22, or rings, are provided. In some aspects the plurality of rings are arranged successively, adjacent one another and/or spaced apart, in any combination, along the axis 14 of the corona charger 1. In some aspects, one or more rings have an outer diameter of approximately 13 mm. In some aspects, three rails 22, or rings, are provided. In some aspects, the at least one interconnect 21 electrically connects each of the plurality of rails 22 to one another. In some aspects, each of the at least one interconnect electrically connects each of the plurality of rails 22 to one another.

In some aspects, the plurality of discharge tips 30 is one, two, three, four, six, or eight discharge tips 30. In some aspects, the plurality of discharge tips 30 are evenly spaced along and/or about the respective rail 22. In some aspects, the plurality of discharge tips 30 are symmetrically spaced along and/or about the respective rail 22. In some aspects, the plurality of discharge tips 30 are symmetrically, but not evenly, spaced along and/or about the respective rails 22. In some aspects, the plurality of discharge tips 30 may be grouped in sets (e.g, pairs) that are distributed along and/or about the respective rails 22. In some aspects, the discharge tips 30 of successive rails 22 are aligned with one another and/or have the same clocking angle. In some aspects, the discharge tips 30 of successive rails 22 are not aligned and/or are disposed at some non-zero clocking angle relative to one another. In some aspects, the discharge tips 30 are each formed from tungsten and/or some other material capable of withstanding the corona and/or capable of withstanding the corona for an acceptable duration or life cycle given the use case.

The corona charger 1 may also include a screen electrode 40 arranged within the outer electrode 20. The screen electrode 40 may be provided with a plurality of perforations 42 therethrough of a size that may permit some portion of the airstream 12, ions, particulates, and/or the like to pass through. The region of the corona charger 1 between the screen electrode 40 and the outer electrode 10 and/or discharge tips 30 may be referred to as the ionization zone 38, or region where the corona forms and ions are generated. The perforations 42 thus at least partially shield the ionization zone 38, reducing electrostatic interference from the airstream 12, while still permitting ions to pass through the screen to attach to particulates in the airstream 12.

In those aspects of FIGS. 1-3, the screen electrode 40 is shaped as a hollow cylinder having an outer diameter that is smaller than an innermost diameter of the plurality of discharge tips 30 such that at least some gap exists between the plurality of discharge tips 30 and the screen electrode 40. Accordingly, the ionization zone 38 exists at some radius of the corona charger 1 between the screen electrode 40 and the outer electrode 20. The screen electrode 40 may be mesh-like, cage-like, and/or screen-like, in that the plurality of perforations 42 may be provided at regular intervals and/or patterns with structural and/or conductive portions therebetween. The screen electrode 40 may further be provided with structural elements 44 for anchoring the screen electrode 40 within the housing 10. In some aspects, one or more of these structural 44 elements may be used to insulate and/or pass one or more conductors 45 to those conductive portions of the screen electrode 40 and/or the ground electrode 50 arranged therein.

The corona charger 1 may further include a ground electrode arranged at or substantially near a center of the corona charger 1 and/or at or substantially near the axis 14 of the corona charger 1. The region of the corona charger 1 between the ground electrode 50 and the screen electrode may be referred to as the charging zone 58, or region where a majority of ions attach to particulates in the airstream 12 if present. As above, the ground electrode 50 may be supported by one or more structural elements 54 that may insulate and/or otherwise pass one or more conductors 55 to those conductive portions of the ground electrode 50.

An onset voltage, or voltage intended to achieve corona onset or corona inception, may be applied across the outer electrode 20 and the screen electrode 40, while a smaller voltage may be applied across the screen electrode 40 and the ground electrode 50. It may be appreciated that the target voltage to be applied as the onset voltage may depend on certain characteristics of the corona charger and the operational conditions, such as the geometry of the corona charger, the composition of the airstream 12, prevailing environmental conditions (e.g., temperature, pressure), flow rates, and/or the like. In some aspects, the onset voltage may be approximately 2.2 kV and the smaller voltage may be approximately 5 V.

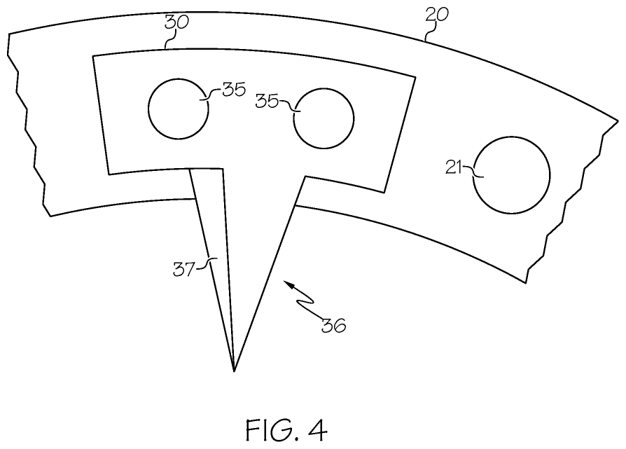

Turning now to FIG. 4, an enlarged view of a discharge tip 30 attached to a rail 20 is shown. The discharge tip 30 has an anchoring portion 34 with one or more posts 35 extending therethrough. The discharge tip 30 further has a tip portion 36 from which the corona or plasma emanates. Also shown is a passthrough for an interconnect 21.

The tip portion 36 of the discharge tip 30 can have any shape (e.g., rounded, square, pointed, bulbous, and/or the like, without limit). Still, it has been found that discharge tips having a pointed geometry require lower onset to achieve corona onset or inception. In some aspects, the tip portion 36 may be formed having a blade-like slope 37 or sharp edge (e.g., a 5.5 degree edge) to further sharpen the point and reduce the onset voltage.

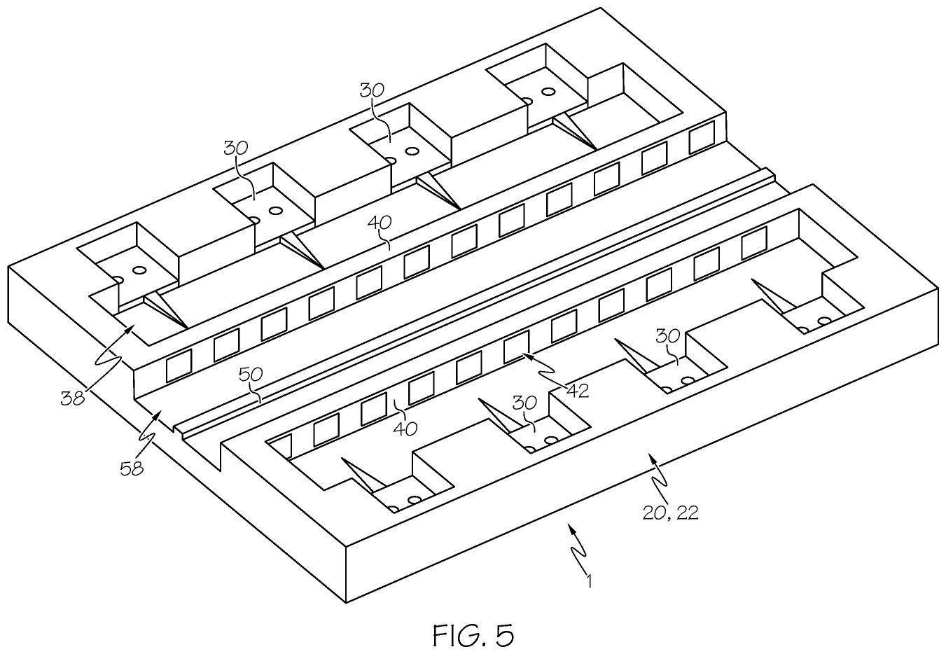

Turning now to FIG. 5, a perspective view of an exemplary corona charger 1 depicting aspects of a linear configuration are shown. Here, the corona charger 1 is substantially rectangular shaped and has a set of outer electrodes 20 each with at least one rail 22 along which are attached a plurality of discharge tips 30. In some aspects, the set of outer electrodes 20 is a pair of outer electrodes 20 arranged opposite one another, each with a single rail 22 along which the discharge tips are arranged. A corresponding set of screen electrodes 40 are provided within the outer electrodes 20, and a ground electrode 50 is arranged within the set of screen electrodes 40. In some aspects, the set of screen electrodes 40 is a pair of screen electrodes 40 likewise arranged opposite one another and within the pair of outer electrodes 20. In some aspects, one or both of the outer electrodes 20 and the screen electrodes 40 are parallel with each other.

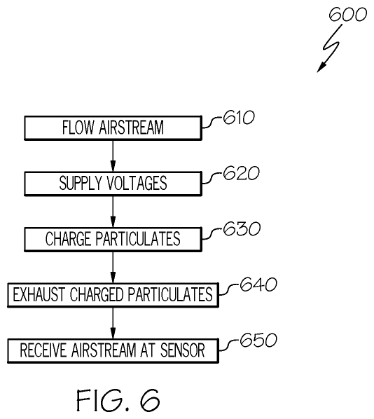

Turning now to FIG. 6, a flow chart depicting an exemplary method 600 for operating the a corona charger 1 further to those disclosures herein is shown. In a step 610, an airstream 12 is flowed through the corona charger 1. The airstream 12 may be driven by a pump, a prevailing pressure differential, respiration, and/or the like, without limit. In some aspects, the flow rate of the airstream 12 may be adjusted or adjustable. The airstream 12 may have entrained therein one or more particulates sought to be detected.

In a step 620, voltages are applied across the electrodes of the corona charger 1. An onset voltage is applied across the outer electrode 20 and the screen electrode 40 to initiate onset and/or inception of the corona. A smaller voltage, or second voltage, is applied across the screen electrode 40 and the ground electrode 50. As discussed above, the onset voltage target may depend on a variety of factors relating to the configuration and/or operational conditions of the corona charger 1. In some aspects, the onset voltage is approximately 2.2 kV. In some aspects, the smaller voltage is 5 V. As a result of the applied voltages, corona onset occurs in the ionization zone 38.

In a step 630, particulates in the airstream 12 are charged by those ions generated from the corona. In some aspects, a majority of the charging occurs in the charging zone 58 between the ground electrode 50 and the screen electrode 40. However, it is contemplated that some leakage may occur and thus some charging may also occur in the ionization zone 38.

In a step 640, the airstream 12 and particulates entrained thereby, including both charged particulates and uncharged particulates, are exhausted from the corona charger 1 through an outlet thereof. Optionally, the exhausted flow may be sent to a suitable sensor in a step 650 for analysis.

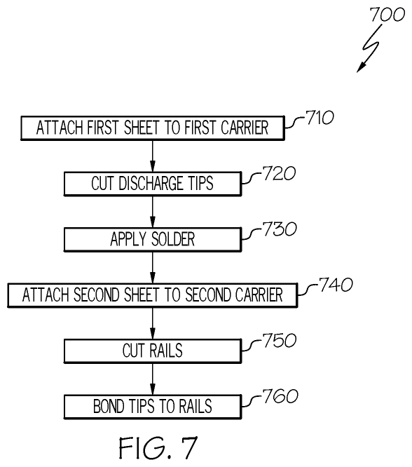

Turning now to FIG. 7, a flow chart depicting an exemplary method 700 for fabricating an outer electrode of the corona charger 1 further to those disclosures herein is shown.

In a step 710, a first metal sheet is attached to a first carrier. The first metal sheet may be, e.g., a tungsten sheet or other suitable material for forming the discharge tips. In a step 720, one or more discharge tips 30 are cut from the first metal sheet, such as via electro-discharge machining or some other comparable process, while remaining attached to the carrier. In some aspects, the discharge tips 30 remain on the carrier in an arrangement similar to that in which the discharge tips 30 would be arranged on the outer electrode 20. Optionally, in a step 730, solder may be applied to the plurality of discharge tips 30, such as via screen printing or some other comparable process.

In a step 740, a second metal sheet is attached to a second carrier. The second metal sheet may be, e.g., a copper sheet or other suitable material for forming the rails 22 of the outer electrode 20. In a step 750, the second metal sheet is patterned to form the rail 22, e.g., via electro-discharge machining, photochemical etching, and/or the like, without limit. Here, too, the rail(s) 22 so formed may remain attached to the carrier in an arrangement similar to that of a final arrangement of the outer electrode 20.

In a step 760, the plurality of discharge tips 30 may be bonded to the rail(s) 22, such as via thermocompression bonding, welding, brazing, and/or the like, without limit. Once bonded, the carriers may be released, dissolved, or otherwise removed, leaving the final outer electrode 20.

It should now be understood that aspects of the present disclosure are directed to corona chargers, methods for using the same, and methods for fabricating components thereof. The corona charger may include an electrode structure comprising an outer electrode, a screen electrode, and a ground electrode for generating ions and charging particulates in an airstream passing through the corona charger. The charged particulates may then be exhausted from the charger and pass on to a sensor for detecting and/or otherwise sorting the same. It has been found that corona chargers configured according with those disclosures herein may achieve loss rates as low as 3.25% at a particle size of 10.55 nm for a charging volume of approximately 385 mm³ and flow rates of approximately 0.6 L/min at ambient conditions.

It is noted that recitations herein of a component of the present disclosure being “configured” in a particular way, to embody a particular property, or to function in a particular manner, are structural recitations, as opposed to recitations of intended use. More specifically, the references herein to the manner in which a component is “configured” denotes an existing physical condition of the component and, as such, is to be taken as a definite recitation of the structural characteristics of the component.

It is noted that the terms “substantially” and “about” and “approximately” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While several aspects have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the aspects described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific aspects described herein. It is, therefore, to be understood that the foregoing aspects are presented by way of example only and that, within the scope of the appended claims and equivalents thereto, aspects may be practiced otherwise than as specifically described and claimed. Aspects of the present disclosure are directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one aspect, to A only (optionally including elements other than B); in another aspect, to B only (optionally including elements other than A); in yet another aspect, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one aspect, to at least one, optionally including more than one, A, with no B present (and optionally including elements other than B); in another aspect, to at least one, optionally including more than one, B, with no A present (and optionally including elements other than A); in yet another aspect, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

It is to be understood that the aspects are not limited in its application to the details of construction and the arrangement of components set forth in the description or illustrated in the drawings. The invention is capable of other aspects and of being practiced or of being carried out in various ways. Unless limited otherwise, the terms “connected,” “coupled,” “in communication with,” and “mounted,” and variations thereof herein are used broadly and encompass direct and indirect connections, couplings, and mountings. In addition, the terms “connected” and “coupled” and variations thereof are not restricted to physical or mechanical connections or couplings.

The foregoing description of several aspects of the invention has been presented for purposes of illustration. It is not intended to be exhaustive or to limit the invention to the precise structure, steps, and/or forms disclosed, and obviously many modifications and variations are possible in light of the above teaching.

1. A corona charger, comprising
an outer electrode comprising at least one rail, wherein each of the at least one rail is provided with a plurality of discharge tips;
a screen electrode provided within the outer electrode; and
a ground electrode provided within the screen electrode, wherein:
the outer electrode, the screen electrode, and the ground electrode are provided within a housing configured to flow an airstream.

2. The corona charger of claim 1, wherein the at least one rail is two rails arranged substantially parallel to one another with the screen electrode therebetween.

3. The corona charger of claim 1, wherein each of the at least one rail is a ring that at least partially encloses the screen electrode.

4. The corona charger of claim 3, wherein the at least one rail is a plurality of rails arranged successively along a common axis.

5. The corona charger of claim 4, wherein at least one interconnect electrically connects the plurality of rails to one another.

6. The corona charger of claim 3, wherein the ring has an outer diameter of approximately 13 mm.

7. The corona charger of claim 1, wherein the plurality of discharge tips each have a pointed end directed towards the screen electrode.

8. The corona charger of claim 1, wherein the plurality of discharge tips are symmetrically distributed about each respective rail.

9. The corona charger of claim 1, wherein the plurality of discharge tips are evenly distributed about each respective rail.

10. The corona charger of claim 1, wherein each plurality of discharge tips is eight discharge tips.

11. The corona charger of claim 1, wherein the screen electrode is provided with perforations through which ions may pass to interact with particulates in the airstream.

12. The corona charger of claim 1, wherein an onset voltage is applied across the outer electrode and the screen electrode, and a second voltage is applied across the screen electrode and the ground electrode.

13. The corona charger of claim 12, wherein the onset voltage is greater than the second voltage.

14. The corona charger of claim 12, wherein the onset voltage is approximately 2.2 kilovolts, and the second voltage is approximately 5 volts.

15. A method for using a corona charger, comprising the steps of:
providing a corona charger, the corona charger comprising:
an outer electrode comprising at least one rail, wherein each of the at least one rail is provided with a plurality of discharge tips;
a screen electrode provided within the outer electrode; and
a ground electrode provided within the screen electrode:
flowing an airstream through the corona charger;
applying an onset voltage across the outer electrode and the screen electrode, and applying a second voltage across the screen electrode and the ground electrode;
charging particulates in the airstream; and
exhausting the charged particulates from the corona charger.

16. The method of claim 15, further comprising the step of:
receiving the charged particulates at a sensor.

17. A method for fabricating an outer electrode of a corona charger, comprising the steps of:
attaching a first metal sheet to a first carrier;
attaching a second metal sheet to a second carrier;
cutting a plurality of discharge tips in the first metal sheet;
cutting a rail in the second metal sheet; and
bonding the plurality of discharge tips to the rail.

18. The method of claim 17, further comprising the step of:
applying a solder to each of the plurality of discharge tips prior to bonding.

19. The method of claim 17, wherein the plurality of discharge tips are cut using electro-discharge machining.

20. The method of claim 17, wherein the ring is formed via at least one of electro-discharge machining and photochemical etching.
